(19) United States
(12) Patent Application Publication
(10) Pub. No.: US 2024/0087278 A1
(43) Pub. Date: Mar. 14, 2024

(54) METHOD AND APPARATUS FOR DETERMINING MARKER POSITION AND ATTITUDE

(71) Applicant: Topcon Positioning Systems, Inc., Livermore, CA (US)

(72) Inventor: Mikhail Yurievich VOROBIEV, Moscow (RU)

(73) Assignee: Topcon Positioning Systems, Inc., Livermore, CA (US)

(21) Appl. No.: 18/255,684

(22) PCT Filed: Apr. 7, 2022
(86) PCT No.: PCT/RU2022/000106

§ 371 Date: Jun. 2, 2023

(51) Int. Cl. G06V 10/22; G06T 7/73; G06V 20/56

(52) U.S. Cl. CPC G06V 10/225; G06T 7/73; G06V 20/56; G06T 2207/10012; G06T 2207/30252

(57) ABSTRACT

A method and apparatus for determining a position and attitude of a marker having encoded information includes the step of acquiring an image of a marker by a stereo camera. A center of the marker is determined and then a position of the marker is determined based on the center of the marker. A plurality of vertices on the marker about the center of the marker are then determined. Using the plurality of vertices, a pitch, roll, and heading of the marker are determined. An attitude of the marker is determined based on the pitch, roll, and heading of the marker. The method and/or apparatus for determining a position and attitude of a marker can be used in various applications to determine the position and attitude of objects on which the marker is located.

### FIELD OF THE INVENTION

The present disclosure relates generally to methods and apparatus for position determination, and, more particularly, to a method and apparatus for determining a position and attitude of a marker.

### BACKGROUND

The position and attitude of an object are often needed to be determined for various reasons. For example, the position and attitude of an agricultural sprayer towed behind a tractor may need to be known in order to determine where in a field liquid has been sprayed to determine compliance with local or national regulations. Machines, such as the agricultural sprayer, may be towed behind a vehicle, such as a tractor. The towed machine is typically rotatably connected to the tractor via a hitch which allows the towed machine to pivot behind the tractor. Thus, the position and attitude of the tractor is not the same as the position and attitude of the towed machine and determining the position and attitude of the tractor may not be sufficient to, for example, determine compliance with regulations. Electronic devices can be placed on towed machines, as well as other types of machines, in order to determine the particular machine's position and attitude. However, mounting electronic devices to each machine can be expensive. In addition, a user may need to know the positions of multiple machines simultaneously which would require the use of multiple electronic devices at even greater expense.

### SUMMARY

In one embodiment, a method and apparatus for determining a position and attitude of a marker includes the step of acquiring an image of the marker by a stereo camera. The marker has encoded information. A position of the marker with respect to a local coordinate system of the stereo camera is determined based on the image. A position of the object with respect to the local coordinate system of the stereo camera is determined based on the position of the marker. In one embodiment the encoded information identifies the object and can also identify where the marker is located on the object. In one embodiment, a location of the stereo camera in a global coordinate system is determined and the location of the object with respect to the global coordinate system can be determined based on the position of the object with respect to the local coordinate system and the location of the stereo camera in the global coordinate system. In one embodiment, a center of the marker is determined and then a position of the marker is determined based on the center of the marker. A plurality of vertices on the marker about the center of the marker are then determined. Using the plurality of vertices, a pitch, roll, and heading of the marker are determined. An attitude of the marker is determined based on the pitch, roll, and heading of the marker.

The method and apparatus for determining a position and attitude of a marker can be used in various applications to determine the position and attitude of objects on which the marker is located. Applications of the method or apparatus include determining a position and attitude of a blade of a bulldozer, determining a position and attitude of an implement towed behind a tractor, controlling movement of a vehicle, determine a position and an attitude of a vehicle, and parking a vehicle based on a position and attitude of a marker. A location of the stereo camera can be used to determine the location of markers and objects or machines on which the markers are located based on the location of the stereo camera.

### BRIEF DESCRIPTION OF THE DRAWINGS

FIG. 1 shows a system located on a vehicle, the system for determining a position and attitude of a marker according to one embodiment;

FIG. 2 shows a marker according to one embodiment;

FIG. 3 shows a coordinate system of a stereo camera, a video sensor of the stereo camera and 2D projection of a marker on the sensor according to an embodiment;

FIG. 4 shows a flow chart of a method for determining a position and attitude of a marker according to one embodiment;

FIG. 5 shows an application of the method of FIG. 4 in which a position and attitude for a blade of a construction machine are determined;

FIG. 6 shows an application of the method of FIG. 4 in which a position and attitude of a towed implement are determined;

FIG. 7 shows an application of the method of FIG. 4 in which movement of a vehicle is controlled based on position and attitude of markers in an environment;

FIG. 8 shows an application of the method of FIG. 4 in which markers are placed on automated or autonomous vehicles to determine vehicle position and attitude; and

FIG. 9 shows an application of the method of FIG. 4 in which markers are placed in parking spaces to allow automated or autonomous vehicles to identify and locate a designated parking space.

### DETAILED DESCRIPTION

A method for determining the position and attitude of a marker utilizes components including a stereo camera that is used to capture images of markers that are located within a field of view (FOV) of the camera. Each of the markers has a unique geometric shape, color, and size which makes the markers easy to find and highlight in left and right camera frames of a stereo camera. The unique geometric shape of each marker consists of encoded information. In one embodiment, the encoded information can be used to identify the marker. Using a triangulation method, the three-dimensional (3D) position and attitude of the marker located in the coordinate system of the stereo camera can be determined. The term position, as used herein, refers to the position of a marker or object in a local coordinate system of the stereo camera (described in detail below). Markers can be placed on objects in order to determine the position and attitude of those objects based on the position and attitude of the corresponding marker placed on the object. Autonomous vehicles or machines (also referred to as automated vehicles or machines) can be controlled based on the position and attitude of markers located in an environment in which the autonomous vehicle operates.

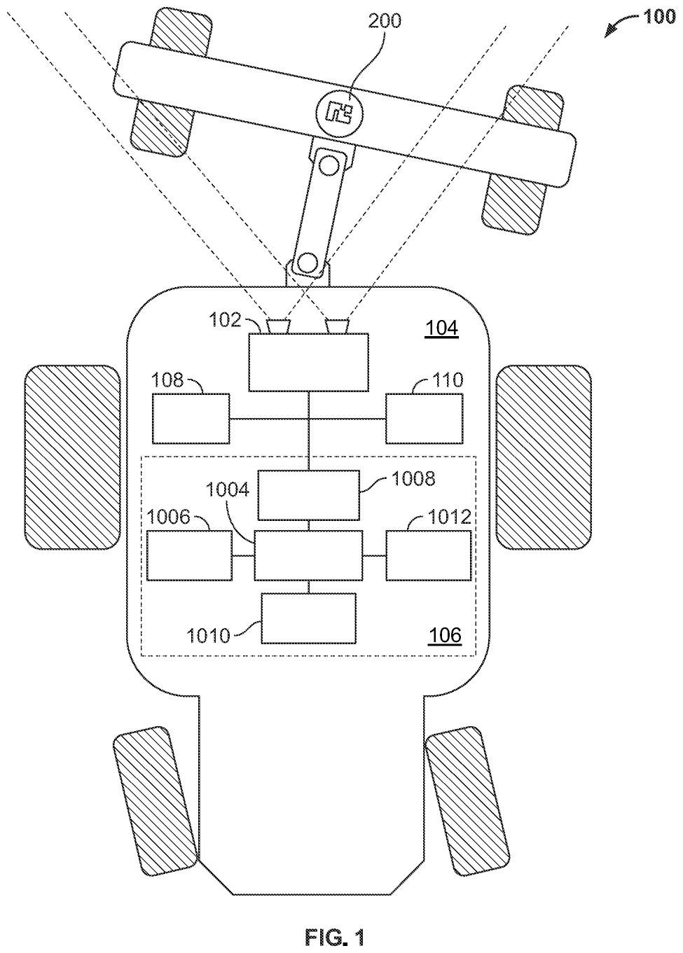

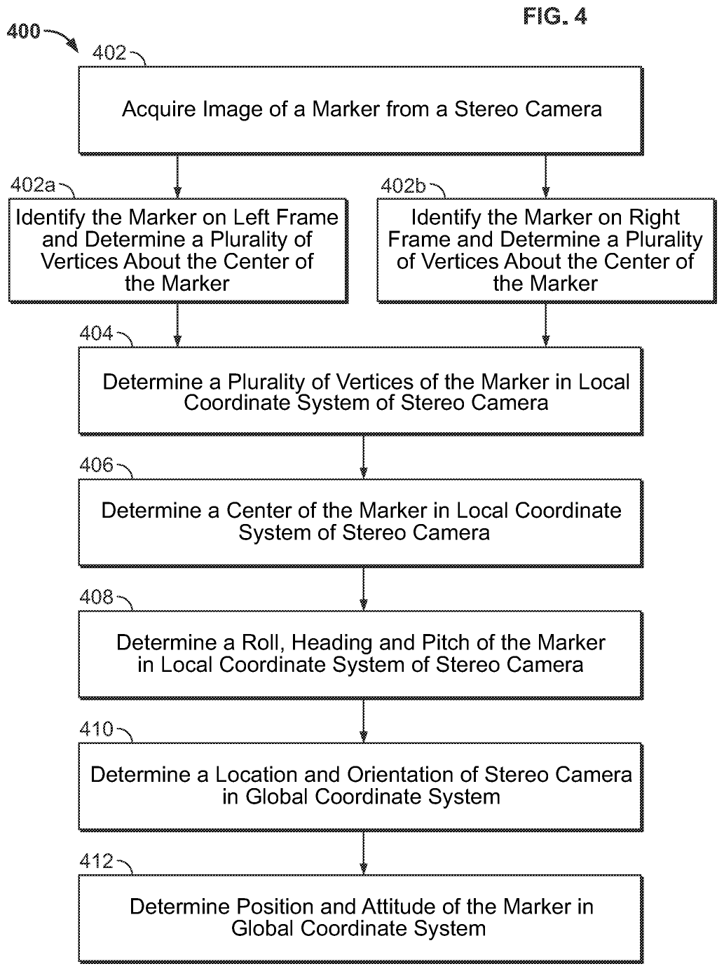

FIG. 1 shows an embodiment of system 100 for determining a position and attitude of a marker in which stereo camera 102 is mounted on vehicle 104. Stereo camera 102, in one embodiment, has two or more lenses with each lens having a separate image sensing device. In various embodiments, stereo camera 102 can be a Stereolabs ZED 2i, a Framos D435e/D455e, or StereoCam 3D stereo camera (2MP). Each lens is arranged to produce a view slightly different than the view from the other lens. The difference in the views can be used to determine the position of objects captured in the images with respect to the stereo camera. Stereo camera 102 is in communication with controller 106 which receives images from stereo camera 102. In one embodiment, stereo camera 102 communicates with controller 106 via an Ethernet or USB3 connection. In various embodiments, controller 106 can be a Rugged Embedded System powered by NVIDIA Jetson AGX/NX Xavier or Orin. Controller 106 is also in communication with navigation system 108 which provides location and orientation information to controller 106. In one embodiment, navigation system 108 is a global navigation satellite system (GNSS). Navigation system 108 can be other types of location and orientation determining systems such as systems using triangulation or other location determination methods. The term location, as used herein, refers to the location of a marker, object, machine, or camera in a coordinate system larger than the local coordinate system of the stereo camera. The larger coordinate system can be a global coordinate system. The global coordinate system can be any type of global coordinate system such as a spherical or ellipsoidal coordinate system using a geodetic datum (e.g., World Geodetic System 1984 (WGS84). Controller 106 is also in communication with vehicle control system 110 which monitors and controls operation of vehicle 104. In one embodiment, controller 106 is in communication with vehicle control system 110 via one of a RS232 connection, CAN, or ethernet. In one embodiment, controller 106 contains a processor 1004 which controls the overall operation of the controller 106 by executing computer program instructions which define such operation. The computer program instructions may be stored in a storage device 1012, or other computer readable medium (e.g., magnetic disk, CD ROM, etc.), and loaded into memory 1010 when execution of the computer program instructions is desired. Thus, the method steps of FIG. 4 (described in detail below) can be defined by the computer program instructions stored in the memory 1010 and/or storage 1012 and controlled by the processor 1004 executing the computer program instructions. For example, the computer program instructions can be implemented as computer executable code programmed by one skilled in the art to perform an algorithm defined by the method steps of FIG. 4. Accordingly, by executing the computer program instructions, the processor 1004 executes an algorithm defined by the method steps of FIG. 4. Controller 106 also includes one or more network interfaces 1006 for communicating with other devices via a network. Controller 106 also includes input/output devices 1008 that enable user interaction with the controller 106 (e.g., display, keyboard, mouse, speakers, buttons, etc.) One skilled in the art will recognize that an implementation of an actual controller could contain other components as well, and that this description of controller 106 is a high-level representation of some of the components of such a controller for illustrative purposes.

In one embodiment, controller 106 analyzes images received from stereo camera 102 in order to identify markers, such as marker 200, shown in images captured by stereo camera 102 within the camera's field of view. In one embodiment, controller 106 determines the position and attitude of the marker with respect to the stereo camera based on the images.

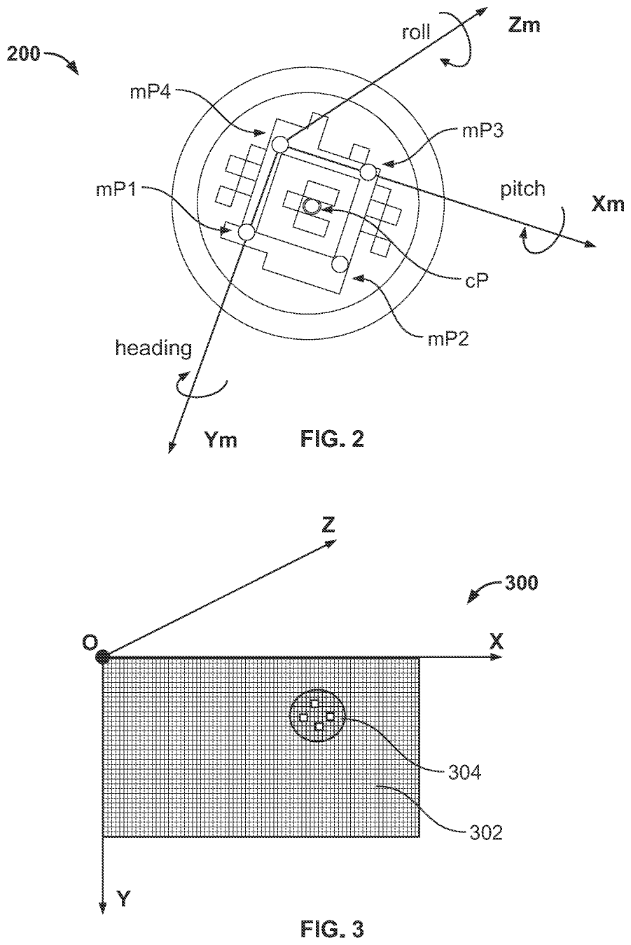

FIG. 2 depicts marker 200 in a local coordinate system of stereo camera 102. In one embodiment, marker 200 has a unique shape and is encoded with information. In one embodiment, the encoded information identifies an object on which marker 200 is located and can also identify where the marker is located on the object. IN one embodiment, marker 200 can be a two-dimensional bar code that is drawn directly on an object or a printed on a material, such as an adhesive backed decal, that can be applied to an object. In one embodiment, each marker can contain up to 12 bits of encoded information. Marker 200, in one embodiment, is an AprilTag target. AprilTag is a system using markers encoded with information (i.e., AprilTag targets) that are captured using one or more cameras. In one embodiment, one of the AprilTags squared tag36h11 (which consists of 587 unique tags) and rounded tag49h12 (which consists of 65535 unique tags) are used. The position and attitude of an AprilTag target can be determined based on images of the AprilTag targets captured using the one or more cameras. As shown in FIG. 2, marker 200 has four vertices mP1, mP2, mP3, and mP4 together forming a flat square located about the center of the marker. In one embodiment, each of the four vertices is located at a corner of the flat square. The four vertices are used to define three axes of marker 200. Axis Xm is defined as the line formed by vertices mP3 and mP4. Axis Ym is defined as the line formed by vertices mP1 and mP4. Axis Zm is orthogonal to both axis Xm and axis Ym and intersects vertex mP4. Rotation about each of the axes is defined as follows. Roll is defined as the clockwise rotation about axis Zm. Pitch is defined as the clockwise rotation about axis Xm. Heading is defined as the clockwise rotation about axis Ym.

FIG. 3 shows local coordinate system 300 of stereo camera 102 according to an embodiment. Stereo camera 102 is located at point O where axes X, Y, and Z intersect. The point O is defined for the left upper corner of the left video sensor 302 of the stereo camera 102. Horizontal axis X is orthogonal to vertical axis Y and both the X and Y axes lie in the plane of the left video sensor and they are orthogonal to axis Z. In one embodiment, the position and attitude of marker 200 are determined with respect to local coordinate system 300 of stereo camera 102. Local coordinate system 300 allows the position of a marker or object to be determined with respect to stereo camera 102 without the use of a larger coordinate system, such as a global coordinate system. The position of any point can be described with respect to stereo camera 102 using the local coordinate system. If the location and orientation of stereo camera 102 in a large coordinate system, such as a global coordinate system, are known, the location of an object having a known position in the local coordinate system can be determined for the large coordinate system.

The parameters of the stereo camera affect various aspects of marker detection. The maximum detection/recognition distance from a marker having a particular size to the camera depends on the angular resolution of the camera. The better the camera's angular resolution, the larger the maximal distance can be between the camera and the markers at which the markers can be detected. In one embodiment, the camera exposure mode uses a global shutter mode to avoid spatial distortion for marker shapes that can move fast relative to the camera. The width of the base of the stereo camera affects the accuracy of marker position determination. In one embodiment, the usage of subpixel resolution requires a 10-centimeter base width for distances of up to 6 meters between the camera and the marker. A 15-centimeter base can be used for distances up to 10 meters between the camera and the marker and maintain a centimeter level of accuracy for marker position determination. The angular resolution of the camera typically depends on the camera's lens characteristics (e.g., field of view) and sensor resolution. The approach described herein can achieve millimeter precision and centimeter level of accuracy (limited by stereo camera calibration) for positioning. The approach can provide sub-degree accuracy for marker attitude determination.

FIG. 4 shows a flow chart of method 400 for determining the position and attitude of marker 200. In one embodiment, controller 106 performs the steps of method 400. At step 402, image of marker 200 is acquired by stereo camera 102. In one embodiment, the marker comprises encoded information and the image acquired by stereo camera 102 comprises two frames, with one frame for each lens of stereo camera 102.

At steps 402a and 402b, marker 200 is identified and a plurality of vertices of 2D projection 304 of marker 200 are determined separately for the left and right frames of the stereo camera 102. In one embodiment, marker identification and vertices determination can be performed using various techniques, such as techniques associated with identification and vertices determination of AprilTags. In one embodiment, AprilTags are detected using an AprilTag detector.

At step 404, vertices mP1, mP2, mP3 and mP4 of marker 200 can be calculated in camera local coordinates system using a triangulation method based on information about 2D vertices of marker projection 304 for both frames that were calculated during the previous step and camera characteristics (e.g., stereo base and calibration data). mP[0] is a value for x-coordinate, mP[1] is a value for y-coordinate, mP[2] is a value for z-coordinate of local camera system 300. As such, index 0 in the array is the x-coordinate, index 1 is the y-coordinate and index 2 is the z-coordinate.

At step 406, a center cP of marker 200 is determined in the camera local coordinates system. In one embodiment, the center of marker 200 in coordinate system 300 shown in FIG. 3 is calculated using the following equations.

cP[0]=(mP1[0]+mP2[0]+mP3[0]+mP4[0])/4

cP[1]=(mP1[1]+mP2[1]+mP3[1]+mP4[1])/4

cP[2]=(mP1[2]+mP2[2]+mP3[2]+mP4[2])/4

where mP1, mP2, mP3 and mP4 are calculated at step 404.

At step 408, the pitch, roll, and heading of marker 200 are determined. In one embodiment, the pitch, roll, and heading of marker 200 are determined based on vertices mP1, mP2, mP3 and mP4 (computed at step 404) as follows.

The roll of marker 200 is expressed as an angle and is determined, in one embodiment, using all four vertices as follows.

roll1=atan 2(mP2[1]−mP1[1],mP2[0]−mP1[0])

roll2=atan 2(mP3[1]−mP4[1],mP3[0]−mP4[0])

roll=(roll1+roll2)/2.

where mP1, mP2, mP3 and mP4 are calculated at step 404.

In one embodiment, intermediate 3D coordinates iP1, iP2, iP3 and iP4 for each of the four vertices of marker 200 are calculated prior to calculation of the heading of marker 200. In one embodiment, intermediate 3D coordinates are calculated as follows.

iP1[0]=mP1[0]*cos(roll)+mP1[1]*sin(roll)

iP1[1]=−mP1[0]*sin(roll)+mP1[1]*cos(roll)

iP1[2]=mP1[2]

iP2[0]=mP2[0]*cos(roll)+mP2[1]*sin(roll)

iP2[1]=−mP2[0]*sin(roll)+mP2[1]*cos(roll)

iP2[2]=mP2[2]

iP3[0]=mP3[0]*cos(roll)+mP3[1]*sin(roll)

iP3[1]=−mP3[0]*sin(roll)+mP3[1]*cos(roll)

iP3[2]=mP3[2]

iP4[0]=mP4[0]*cos(roll)+mP4[1]*sin(roll)

iP4[1]=−mP4[0]*sin(roll)+mP4[1]*cos(roll)

iP4[2]=mP4[2]

where mP1, mP2, mP3 and mP4 are calculated at step 404.

The heading of marker 200 is expressed as an angle and is determined, in one embodiment, as follows.

heading1=−atan2(iP2[2]−iP1[2],iP2[0]−iP1[0])

heading 2=−atan2(iP3[2]−iP4[2],iP3[0]−iP4[0])

heading=(heading 1+heading 2)/2

In one embodiment, intermediate 3D coordinates jP1, jP2, jP3 and jP4 for each of the four vertices of marker 200 are calculated prior to calculation of the pitch of marker 200. In one embodiment, intermediate 3D coordinates are calculated as follows.

jP1[0]=iP1[0]*cos(heading)−iP1[2]*sin(heading)

jP1[1]=iP1[1]

jP1[2]=iP1[0]*sin(heading)+iP1[2]*cos(heading)

jP2[0]=iP2[0]*cos(heading)−iP2[2]*sin(heading)

jP2[1]=iP2[1]

jP2[2]=iP2[0]*sin(heading)+iP2[2]*cos(heading)

jP3[0]=iP3[0]*cos(heading)−iP3[2]*sin(heading)

jP3[1]=iP3[1]

jP3[2]=iP3[0]*sin(heading)+iP3[2]*cos(heading)

jP4[0]=iP4[0]*cos(heading)−iP4[2]*sin(heading)

jP4[1]=iP4[1]

jP4[2]=iP4[0]*sin(heading)+iP4[2]*cos(heading)

where iP1, iP2, iP3 and iP4 are calculated at previous step.

The pitch of marker 200 is expressed as an angle and is determined, in one embodiment, as follows.

pitch1=atan2(jP1[2]−jP4[2],jP1[1]−jP4[1])

pitch2=atan2(jP2[2]−jP3[2],jP2[1]−jP3[1])

pitch=(pitch1+pitch2)/2

At step 410, a location and orientation of stereo camera 102 are determined. In one embodiment, the location and orientation of stereo camera 102 are determined based on information controller 106 receives from navigation system 108. In one embodiment, navigation system 108 determines its location and orientation and transmits these data to controller 106. In one embodiment, the data is longitude, latitude, height coordinates and orientation angles (pitch, roll and heading) of the vehicle 104 identifying the location and orientation of navigation system 108. The location and orientation of stereo camera 102 are determined based on its location and orientation on vehicle 104 relative to navigation system 108. In one embodiment, the relative location and orientation of stereo camera 102 with respect to navigation system 108 is stored in controller 106 and controller 106 can determine the location and orientation of stereo camera 102 based on the location information received from navigation system 108.

At step 412, a position of marker 200 is determined in a global coordinate system. In one embodiment, the position of marker 200 is determined based on the position of the center of marker 200 as determined in step 406. The position of the center of marker 200 is known in coordinate system 300 of stereo camera 102. Since the location and orientation of stereo camera 102 are known from step 410, and the position of the center of marker 200 with respect to stereo camera 102 is known, the location of marker 200 can also be determined. At the same step, an attitude of marker 200 is determined based on the pitch, roll, and heading of marker 200 determined in step 408. Since the location and orientation of stereo camera 102 are known from step 410, and the attitude of marker 200 with respect to stereo camera 102 is known from step 408, the attitude of marker 200 can also be determined in the global coordinate system. It should be noted that method 400 is a non-contact method for determining a position and attitude of a marker.

The determined position and attitude of a marker can be used to determine a position and attitude of an object on which one or more markers are located. Method 400 for determining the position and attitude of marker 200 can be used in various applications. For example, applications can use one or more markers in order to determine a position and/or attitude of an object on which the markers are located. Several such applications are described as follows.

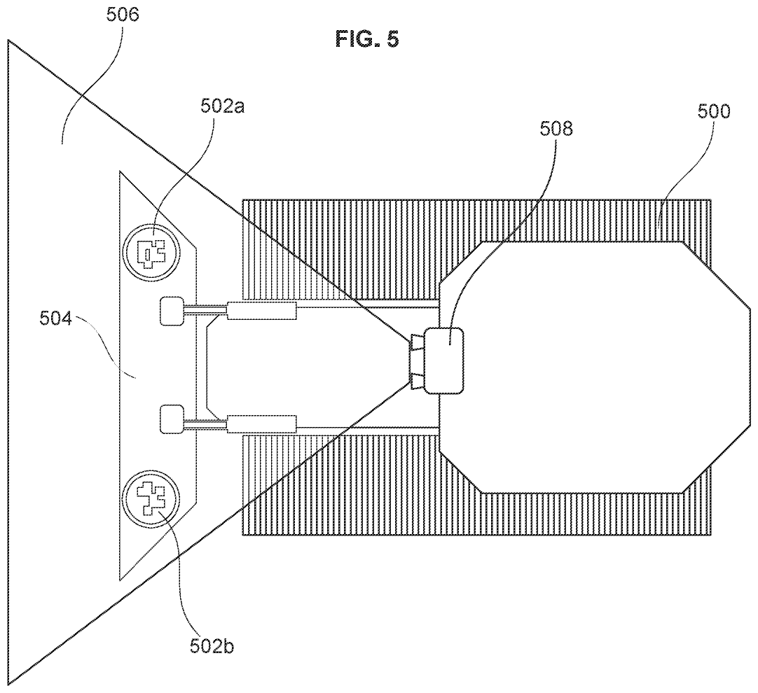

FIG. 5 shows an application of method 400 for determining marker position and attitude in which the markers are located on a construction machine. Bulldozer 500 has blade 504 that can be used for grading and other surface modification operations. Markers 502a and 502b are placed on blade 504 in field of view 506 of a stereo camera 508 located on bulldozer 500. The position and attitude of blade 504 in the local coordinate system of the stereo camera 102 can be determined based on the positions and attitudes of markers 502a and 502b that are located on the blade 504 using the techniques described above. The position and attitude of blade 504 in a world coordinate system can be determined based on the location of bulldozer 500 and the position and attitude of blade 504 in the local coordinate system. In one embodiment, stereo camera 102 can be located on a mast arranged to have moving markers located within the camera's field of view. The non-contact nature of method 400 allows computing of the three-dimensional position and orientation of machines and machine implements, estimation of a volume of a material prism (e.g., a soil prism) to prevent its passage through a blade, and determination of a speed of a tracked vehicle to compare with the speed of the vehicle's tracks in order to calculate a coefficient characterizing a degree of slippage of the vehicle when moving under different conditions (e.g., heavy loading).

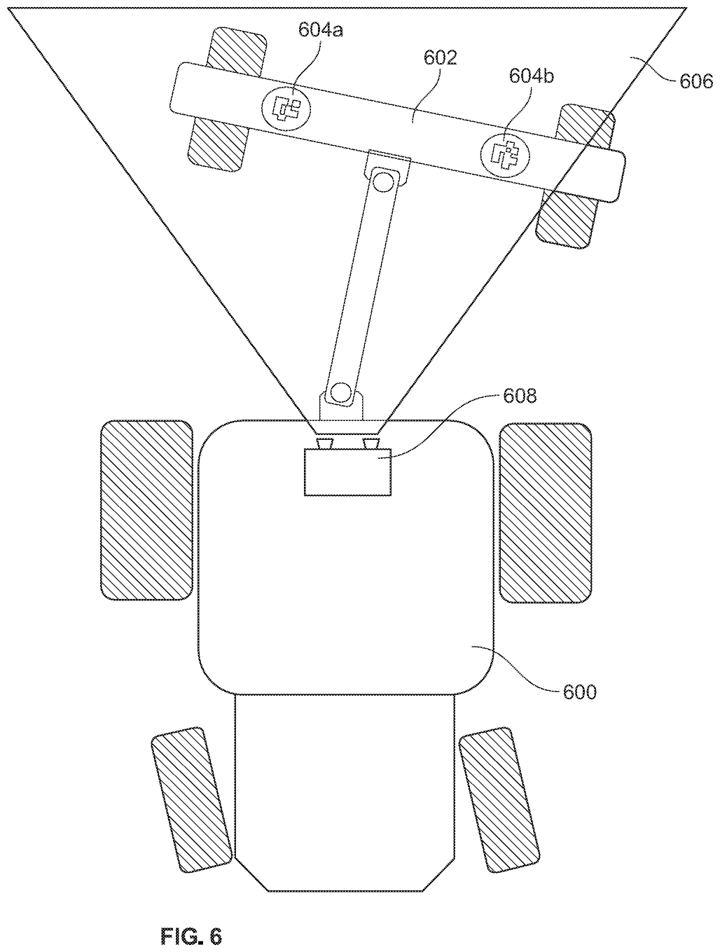

FIG. 6 shows an application of method 400 for determining marker position and attitude in which markers are located on towed implement 602. Tractor 600 pulls towed implement 602 which is configured to perform an agricultural operation. The position and attitude of towed implement 602 is known based on the position and attitude of markers 604a and 604b which are located in field of view 606 of stereo camera 608 mounted on tractor 600. In one embodiment, the method described herein can be used to estimate the height of towed implement 602. As such, operations requiring monitoring of a marker's height, such as depth of a plow sinking into the ground, can be determined.

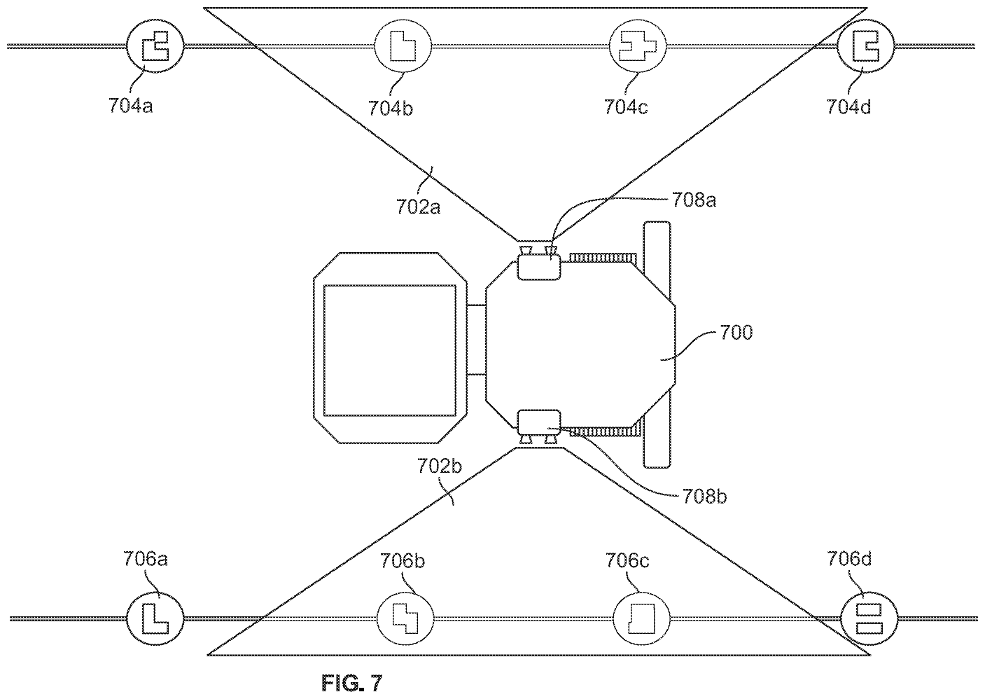

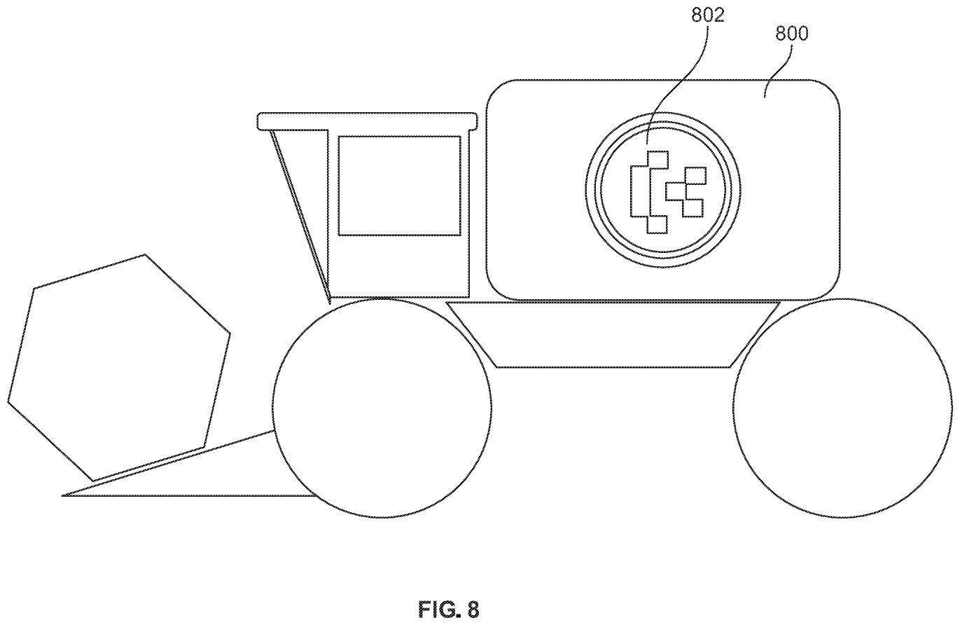

FIG. 7 shows an application of method 400 for determining marker position and attitude in which movement of a vehicle 700 (e.g., an asphalt paver) is controlled based on markers located in an environment in which the vehicle is operating. Vehicle 700 is shown travelling through a tunnel having markers 704a, 704b, 704c, 704d located on a fixed object in the environment (e.g., one wall of the tunnel) and markers 706a, 706b, 706c, and 706d located on an opposite fixed object in the environment (e.g., an opposite wall of the tunnel). The markers are detected by one or more stereo cameras 708a and 708b (e.g., one stereo camera pointed to one side of vehicle 700 and one stereo camera pointed to the opposite side of vehicle 700). Markers 704b and 704c are shown located within field of view 702a of a stereo camera 708a pointed to one side of vehicle 700. Markers 706b and 706c are shown located within field of view 702b of a stereo camera 708b pointed to an opposite side of vehicle 700. In one embodiment, the location of each marker is based on the field of view of each stereo camera so that at least one marker on each tunnel wall is in the field of view of the respective stereo camera as it moves. In one embodiment, the marker's position relative to the start point of the tunnel is encoded in marker shape. For example, the marker ID reflects the distance of marker in meters relative to the beginning of the tunnel. The position and attitude of the markers located in the fields of view of the stereo cameras are used to determine the position and attitude of the vehicle with respect to the markers based on the position and attitude of the stereo cameras. The movement of the vehicle (e.g., the speed and direction) is controlled based on the determined location of the vehicle and the markers. Accordingly, the method is useful in controlling movement and operation of autonomous vehicles or/and when the GNSS system cannot be used (e.g., when GNSS signals cannot be received inside the tunnel). In one embodiment, markers can be placed about the periphery of an area (e.g., on the walls surrounding a room) in order to determine the location of a machine within the area. For example, the machine's local coordinates inside the room can be determined by triangulation if one or more markers' positions in the local coordinate system are known.

FIG. 8 shows an application of the method 400 for determining marker position and attitude in which markers are located on a plurality of autonomous or automated vehicles. Markers located on each vehicle allow other vehicles to identify and determine the position and attitude of each vehicle. Combine 800 is shown having marker 802 which allows other autonomous or automated vehicles to identify it and localize its position and orientation. Such information can be used for a collision avoidance system when autonomous or automated vehicles are used as a group.

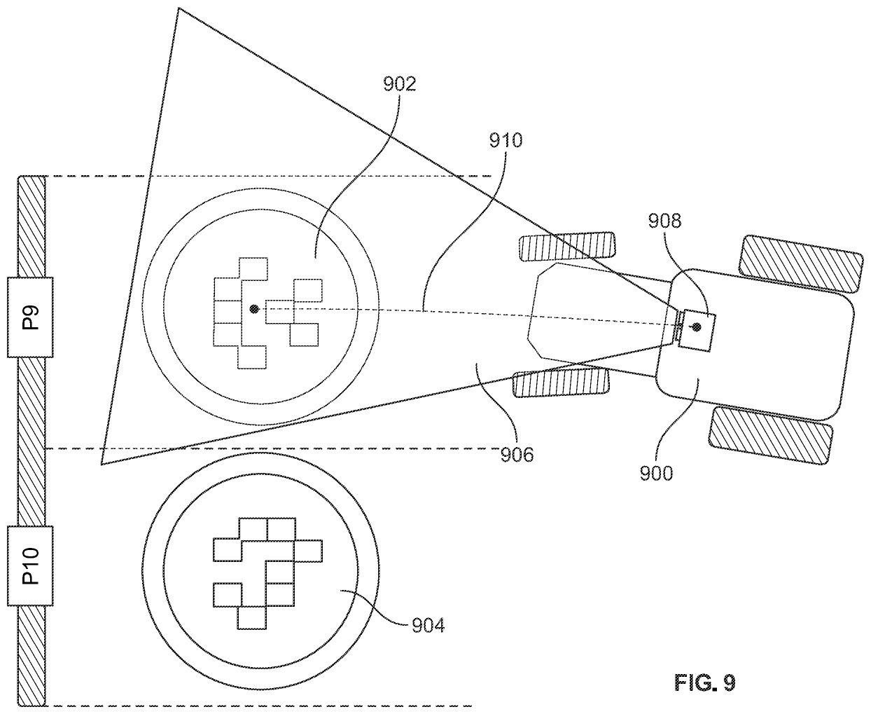

FIG. 9 shows an application of method 400 for determining marker position and attitude in which markers are placed in parking spots (e.g., drawn or painted on a parking space) where automated or autonomous vehicles are to be parked. Tractor 900 has stereo camera 908 for capturing images of markers. Vehicle parking spaces P9 and P10 are identified using markers 902 and 904, respectively. Stereo camera 908 of tractor 900 captures images of markers located within the stereo camera's field of view 906. Markers 902 and 904 identify their respective parking spaces and allow tractor 900 to move into a designated space based on the position and attitude of a respective marker. In one embodiment, the autonomous vehicle makes approach 910 to parking space P9 trying to simultaneously minimize the distance between camera and marker 902 and roll angle for the marker 902.

The foregoing Detailed Description is to be understood as being in every respect illustrative and exemplary, but not restrictive, and the scope of the inventive concept disclosed herein should be interpreted according to the full breadth permitted by the patent laws. It is to be understood that the embodiments shown and described herein are only illustrative of the principles of the inventive concept and that various modifications may be implemented by those skilled in the art without departing from the scope and spirit of the inventive concept. Those skilled in the art could implement various other feature combinations without departing from the scope and spirit of the inventive concept.

1. A method comprising:
acquiring from a stereo camera an image of a marker on an object, wherein the marker comprises encoded information;
determining a position of the marker with respect to a local coordinate system of the stereo camera based on the image; and
determining a position of the object with respect to the local coordinate system of the stereo camera based on the position of the marker.

2. The method of claim 1, wherein the encoded information identifies the object.

3. The method of claim 2, wherein the encoded information identifies where the marker is located on the object.

4. The method of claim 1, further comprising:
determining a position and orientation of the stereo camera in a global coordinate system; and
determining a location of the object in the global coordinate system based on the position of the object with respect to the local coordinate system and the location of the stereo camera in the global coordinate system.

5. The method of claim 1, further comprising:
determining a center of the marker based on the image,
wherein the determining the position of the marker with respect to the local coordinate system of the stereo camera is further based on the center of the marker.

6. The method of claim 1, further comprising:
determining a roll of the marker;
determining a heading of the marker;
determining a pitch of the marker; and
determining an attitude of the marker based on the pitch, the roll, and the heading of the marker.

7. The method of claim 6, further comprising:
determining an attitude of the object based on the attitude of the marker.

8. The method of claim 6, further comprising:
determining a plurality of vertices about a center of the marker,
wherein the determining the attitude of the marker is further based on the plurality of vertices.

9. The method of claim 3, wherein the determining a position of the object is further based on where the marker is located on the object.

10. The method of claim 1, wherein the stereo camera is attached to a machine and the object is an implement attached to the machine.

11. The method of claim 10, wherein the machine is a bulldozer and the implement is a blade.

12. The method of claim 10, wherein the machine is a tractor and the object is a towed machine.

13. The method of claim 1, wherein the stereo camera is attached to a first vehicle and the object is a second vehicle.

14. A method comprising:
acquiring an image of a marker from a stereo camera attached to a machine, the marker located in an environment in which the machine is located and comprising encoded information;
determining a position of the marker with respect to a local coordinate system of the stereo camera based on the image; and
determining a location of the machine with respect to a global coordinate system based on the position of the marker with respect to a local coordinate system of the stereo camera and the encoded information.

15. The method of claim 14, wherein the encoded information identifies the location of the marker in the environment with respect to the global coordinate system.

16. The method of claim 15, wherein the machine is an asphalt paver and the marker is located on a fixed object in the environment.

17. The method of claim 15, wherein the machine is a vehicle, and the marker is located on a fixed object.

18. The method of claim 15, wherein the machine is a first vehicle, and the marker is located on a second vehicle.

19. An apparatus comprising:
a stereo camera;
a controller in communication with the stereo camera, the controller configured to perform operations comprising:
acquiring from the stereo camera an image of a marker on an object, wherein the marker comprises encoded information;
determining a position of the marker with respect to a local coordinate system of the stereo camera based on the image; and
determining a position of the object with respect to the local coordinate system of the stereo camera based on the position of the marker.

20. The apparatus of claim 19, wherein the encoded information identifies the object.

21. The apparatus of claim 20, wherein the encoded information identifies where the marker is located on the object.

22. The apparatus of claim 21, wherein the determining the position of the object is further based on where the marker is located on the object.

23. The apparatus of claim 19, the operations further comprising:
determining a location of the stereo camera in a global coordinate system; and
determining a location of the object in the global coordinate system based on the position of the object with respect to the local coordinate system and the location of the stereo camera in the global coordinate system.

24. The apparatus of claim 19, the operations further comprising:
determining a roll of the marker;
determining a heading of the marker;
determining a pitch of the marker; and
determining an attitude of the marker based on the pitch, the roll, and the heading of the marker.
